(19) United States
(12) Patent Application Publication
(10) Pub. No.: US 2015/0157963 A1
(43) Pub. Date: Jun. 11, 2015

(54) FILTER ASSEMBLY FOR USE IN A NATURAL GAS LIQUEFACTION SYSTEM AND METHOD OF OPERATING THE SAME

(71) Applicant: General Electric Company, Schenectady, NY (US)

(72) Inventors: Vitali Victor Lissianski, Schenectady, NY (US); Douglas Carl Hofer, Clifton Park, NY (US); Ching-Jen Tang, Watervliet, NY (US); Irfan Saif Hussaini, Glenville, NY (US)

(73) Assignee: General Electric Company, Schenectady, NY (US)

(21) Appl. No.: 14/101,678

(22) Filed: Dec. 10, 2013

(51) Int. Cl. B01D 29/66

(52) U.S. Cl. CPC B01D 29/668

(57) ABSTRACT

A filter assembly for use in a natural gas liquefaction system is provided. The filter assembly includes a filter house that includes a first portion, a filter element positioned within the first portion and configured to collect solids entrained in slurry on a surface thereof, and a valve coupled to the first portion. A cleaning system is coupled to the filter house and configured to remove the solids from the surface of said filter element. The valve selectively actuates to facilitate removal of the solids from the surface of the filter element and channeling of the solids from the first portion through the valve.

### BACKGROUND

The present disclosure relates generally to liquid natural gas production and, more specifically, to systems and methods of removing solids entrained in a liquid natural gas stream.

Generally, natural gas refers to a methane-rich gas mixture that can include carbon dioxide, nitrogen, hydrogen sulfide, other hydrocarbons, and moisture in various proportions. In at least some known applications, natural gas is used as an alternative to other known fuels such as gasoline and diesel. For example, natural gas generally burns cleaner and produces less carbon dioxide during combustion when compared to some other known fuels. To be used as an alternative fuel, or to facilitate storage and/or transport, natural gas is typically processed to convert the natural gas into liquefied natural gas (LNG).

Liquefaction refers generally to the process used to convert natural gas into LNG. More specifically, liquefying natural gas includes cooling the natural gas to about the liquefaction temperature of methane, which is about −161° C. under atmospheric pressure. Because constituents of natural gas such as moisture and carbon dioxide have higher freezing points than methane, they will solidify when cooled to the liquefaction temperature of methane forming LNG-rich slurry. The LNG-rich slurry is generally unsuitable for use as alternative fuel.

At least one known method of forming purified LNG is to remove the constituents in the raw natural gas before cooling it to the liquefaction temperature of methane. However, known removal systems are costly to implement and generally have a relatively large ecological and/or physical footprint. Other known methods of forming purified LNG include removing the solidified constituents from a LNG-rich slurry after liquefaction of the natural gas. More specifically, the solidified constituents may be removed via gravity separation and/or cyclone separation. Even though such removal methods are generally effective at removing relatively large solidified particles from the LNG-rich slurry, they are less effective at removing smaller particles.

### BRIEF DESCRIPTION

In one aspect, a filter assembly for use in a natural gas liquefaction system is provided. The filter assembly includes a filter house that includes a first portion, a filter element positioned within the first portion and configured to collect solids entrained in slurry on a surface thereof, and a valve coupled to the first portion. A cleaning system is coupled to the filter house and configured to remove the solids from the surface of said filter element. The valve selectively actuates to facilitate removal of the solids from the surface of the filter element and channeling of the solids from the first portion through the valve.

In another aspect, a method of operating a natural gas liquefaction system is provided. The method includes channeling a slurry including liquefied natural gas and solidified carbon dioxide towards a filter house, collecting the solidified carbon dioxide on a filter element in the filter house to form a flow of purified liquefied natural gas, and directing a pulse of cleaning fluid through the filter element to remove the solidified carbon dioxide therefrom, wherein the cleaning fluid includes at least one of methane and carbon dioxide.

In yet another aspect, a method of operating a natural gas liquefaction system is provided. The method includes channeling a slurry including liquefied natural gas and solidified carbon dioxide towards a filter house, collecting the solidified carbon dioxide on a filter element in the filter house to form a flow of purified liquefied natural gas, and directing a flow of cleaning fluid through the filter element at a temperature that melts at least a portion of the solidified carbon dioxide to facilitate removing the solidified carbon dioxide from the filter element.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an exemplary liquefaction system;

FIG. 2 is a cross-sectional view of an exemplary filter assembly that may be used with the liquefaction system shown in FIG. 1 in a first operational mode;

FIG. 3 is a cross-sectional view of the filter assembly shown in FIG. 2 in a second operational mode;

FIG. 4 is a schematic diagram of an exemplary cleaning system that may be used with the filter assembly shown in FIG. 2; and

FIG. 5 is a schematic diagram of an alternative cleaning system that may be used with the filter assembly shown in FIG. 2.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, Such ranges are identified and include all the sub-ranges contained therein unless context or language indicates otherwise.

Embodiments of the present disclosure relate to assemblies and methods of purifying liquefied natural gas (LNG). In the exemplary embodiment, LNG is purified by directing a flow of LNG-rich slurry towards a filter assembly and collecting solids entrained in the LNG-rich slurry in the filter assembly to form a flow of purified LNG. During operation, collected solids will continuously accumulate and undesirably increase a pressure drop across the filter assembly. As such, in the exemplary embodiment, the filter assembly also includes a cleaning system for use in removing the collected solids from the filter assembly after prolonged use. More specifically, the cleaning system removes the collected solids by either directing a pressurized pulse of cleaning fluid through the filter assembly, or by melting the collected solids with a flow of cleaning fluid directed through the filter assembly. The cleaning fluid is formed from material that will not adversely affect the natural gas liquefaction system. More specifically, the cleaning fluid is formed from material that is substantially unreactive with natural gas flowing through the liquefaction system. As such, the assemblies and methods described herein facilitate removing smaller particles entrained in the LNG-rich slurry than other known systems to facilitate forming purified LNG.

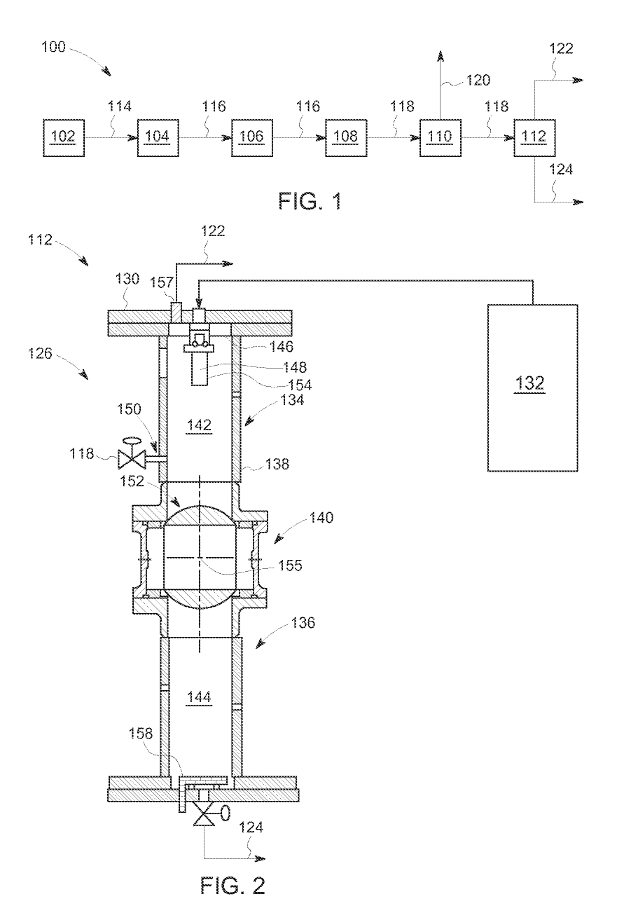

FIG. 1 is a schematic diagram of an exemplary liquefaction system 100. In the exemplary embodiment, liquefaction system 100 includes a natural gas source 102, a moisture removal system 104 coupled downstream from natural gas source 102, and a heat exchanger 106 coupled downstream from moisture removal system 104. Moreover, liquefaction system 100 includes an expansion system 108 coupled downstream from heat exchanger 106, a flash separator 110 coupled downstream from expansion system 108, and a filter assembly 112 coupled downstream from flash separator 110.

In operation, unpurified, pressurized natural gas 114 is channeled from natural gas source 102 towards moisture removal system 104. Natural gas 114 primarily includes methane, and secondarily includes impurities including, but not limited to, moisture and carbon dioxide. Because the freezing point of moisture at atmospheric conditions is about 0° C., it has to be removed from natural gas 114 prior to being channeled towards heat exchanger 106 to form a flow of substantially moisture-free natural gas 116. In the exemplary embodiment, moisture may be removed from natural gas 114 via absorption and/or adsorption.

Natural gas 116 is then channeled towards heat exchanger 106, expansion system 108, and flash separator 110 to facilitate liquefying natural gas 116. More specifically, because carbon dioxide generally has a higher freezing point (i.e., about −78° C. at atmospheric pressure) than the natural gas liquefaction temperature, cooling and expanding natural gas 116 facilitates forming a liquefied natural gas (LNG) rich slurry 118 including liquefied natural gas and solidified carbon dioxide. The pressure and temperature of natural gas 116 discharged from heat exchanger 106 is selected to facilitate reducing the likelihood of carbon dioxide from freezing in heat exchanger 106. Exemplary expansion systems include, but are not limited to, a Joule-Thompson expansion valve and a turbine. Alternatively, natural gas 116 is liquefied via any suitable process. Moreover, a flow of methane vapor 120 is discharged from flash separator 110. In the exemplary embodiment, LNG-rich slurry 118 is then channeled towards filter assembly 112 to facilitate separating LNG from solidified carbon dioxide to form a flow of purified LNG 122 and a flow of carbon dioxide 124.

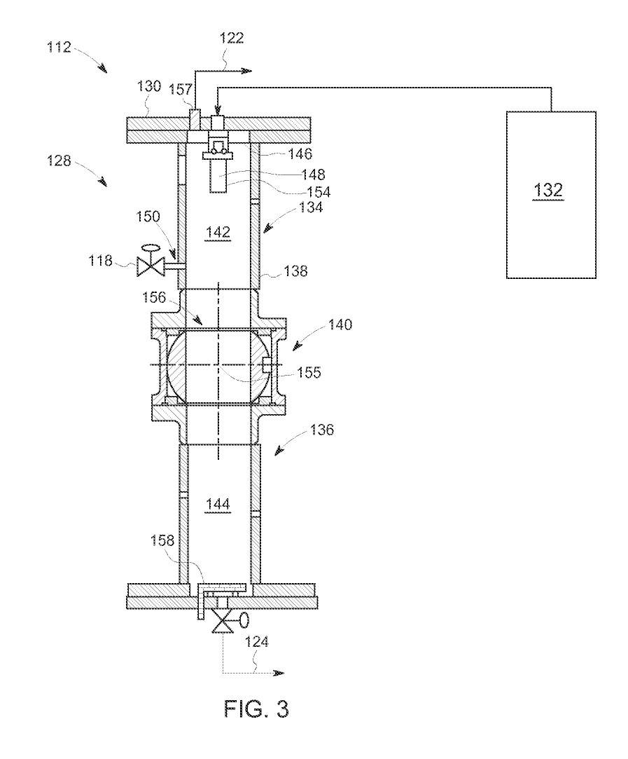

FIG. 2 is a cross-sectional view of an exemplary filter assembly 112 in a first operational mode 126, and FIG. 3 is a cross-sectional view of filter assembly 112 in a second operational mode 128. In the exemplary embodiment, filter assembly 112 includes a filter house 130 and a cleaning system 132. Filter house 130 includes a first, upper portion 134, a second, lower portion 136, and a valve 140 positioned between upper and lower portions 134 and 136. More specifically, valve 140 is coupled to each of upper and lower portions 134 and 136. Valve 140 facilitates defining a first plenum 142 in upper portion 134, and a second plenum 144 in lower portion 136.

In the exemplary embodiment, filter house 130 also includes a tube sheet 146 coupled to a side wall 138 in first plenum 142, and a filter element 148 coupled to tube sheet 146. Filter element 148 is formed from any material that enables filter house 130 to function as described herein. Exemplary filter element materials include, but are not limited to, a ceramic material or a sintered metallic material having pore sizes capable of filtering particles greater than about 0.1 micrometers in size. As used herein, the term “metallic” may refer to a single metallic material or a metallic alloy material. Moreover, valve 140 is any valve that enables filter house 130 to function as described herein including, without limitation, ball valves and butterfly valves. In the exemplary embodiment, valve 140 selectively actuates during operation of filter assembly 112 to facilitate removing solidified carbon dioxide from filter house 130, as will be described in more detail below. More specifically, valve 140 actuates between a closed position 152 and an open position 156 about an axis of rotation 155.

In operation, when filter assembly 112 operates in first operational mode 126, LNG-rich slurry 118 is channeled into filter house 130 through an LNG inlet 150 while valve 140 is in closed position 152. More specifically, LNG-rich slurry 118 is channeled into upper portion 134 of filter house 130 and substantially fills first plenum 142. LNG-rich slurry 118 is then channeled through filter element 148 such that solidified carbon dioxide is collected on a surface 154 of filter element 148 and purified LNG 122 is discharged from filter house 130 through an LNG outlet 157 defined in filter house 130.

As collected carbon dioxide continuously accumulates on surface 154 of filter element 148, a pressure drop across filter element 148 will increase to undesirable levels after prolonged operation of filter house 130. As such, when filter house 130 operates in second operational mode 128, the flow of LNG-rich slurry 118 into filter house 130 is stopped, and valve 140 actuates into open position 156 to facilitate cleaning filter element 148. More specifically, as will be described in more detail below, cleaning system 132 is inoperable in first operation mode 126, and cleaning system 132 facilitates removing solidified carbon dioxide from surface 154 of filter element 148 in second operational mode 128. As solidified carbon dioxide is removed from filter element 148, it gravitates towards lower portion 136 and valve 140 in open position 156 facilitates channeling the carbon dioxide from upper portion 134 towards lower portion 136. After filter element 148 has been cleaned, valve 140 is actuated into closed position 152 and filtration of LNG-rich slurry 118 resumes.

In the exemplary embodiment, a heater 158 is positioned within lower portion 136 of filter house 130. More specifically, heater 158 is positioned within second plenum 144 and facilitates liquefying and/or sublimating the solidified carbon dioxide removed from filter element 148 and channeled into second plenum 144. As such, heater 158 heats the solidified carbon dioxide and a flow of carbon dioxide 124 is then removed from lower portion 136 of filter house 130. After carbon dioxide 124 is removed, cleaning system 132 is ready for another cleaning cycle of filter element 148.

In an alternative embodiment, liquefaction system 100 may include more than one filter assembly 112. More specifically, the filter assemblies may operate in parallel to enable continuous production of purified LNG when one of the filter assemblies is shut down to remove solidified carbon dioxide therefrom.

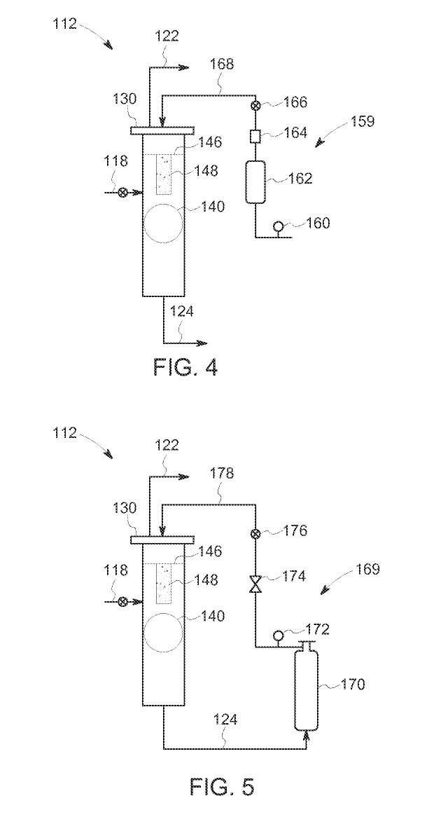

FIG. 4 is a schematic diagram of an exemplary cleaning system 159 that may be used with filter house 130. In the exemplary embodiment, cleaning system 159 is a non-limiting embodiment of cleaning system 132 (shown in FIGS. 2 and 3). Cleaning system 159 includes a pressure regulator 160, a cleaning fluid storage tank 162, a solenoid valve 164, and a shutoff valve 166 that are each coupled in series in a cleaning fluid distribution line 168. Cleaning system 159 is operable when filter assembly 112 is in second operational mode 128 (shown in FIG. 3) to facilitate removing solidified carbon dioxide from filter element 148. More specifically, cleaning system 159 directs a pressurized pulse of cleaning fluid through filter element 148 to remove the solidified carbon dioxide therefrom.

Cleaning fluid is any fluid that enables cleaning system 159 to function as described herein. More specifically, the cleaning fluid selected should be substantially unreactive with LNG flowing through liquefaction system 100. For example, introducing air into liquefaction system 100 may form a combustible mixture of air and natural gas. As such, exemplary cleaning fluids used in cleaning system 159 include, but are not limited to, methane, nitrogen, and carbon dioxide. In the exemplary embodiment, methane vapor 120 from flash separator 110 (both shown in FIG. 1) is directed towards and stored in cleaning fluid storage tank 162 to be used as the cleaning fluid. In an alternative embodiment, if methane refrigeration is used to liquefy natural gas, a portion of methane from the refrigeration system may be used as the cleaning fluid. Alternatively, carbon dioxide 124 recovered from filter house 130 may be vaporized and recycled to filter house 130 to be used as the cleaning fluid.

FIG. 5 is a schematic diagram of an alternative cleaning system 169 that may be used with filter house 130. In the exemplary embodiment, cleaning system 169 is a non-limiting embodiment of cleaning system 132 (shown in FIGS. 2 and 3). Cleaning system 169 includes a cleaning fluid storage tank 170, a pressure regulator 172, a flow controller 174, and a shutoff valve 176 that are each coupled in series in a cleaning fluid distribution line 178. Cleaning system 169 is operable when filter assembly 112 is in second operational mode 128 (shown in FIG. 3) to facilitate removing solidified carbon dioxide from filter element 148. Cleaning system 169 directs a flow of cleaning fluid through filter element 148 at a temperature that melts at least a portion of the solidified carbon dioxide to facilitate removing the solidified carbon dioxide from filter element 148. More specifically, the cleaning fluid is directed at a temperature and pressure such that the solidified carbon dioxide melts and the cleaning fluid condenses simultaneously. As such, the latent heat of the cleaning fluid is used to melt the solidified carbon dioxide and facilitate reducing the amount of cleaning fluid required to melt the solidified carbon dioxide.

The cleaning fluid is any fluid that enables cleaning system 169 to function as described herein. As described above, the cleaning fluid selected should be substantially unreactive with LNG flowing through liquefaction system 100. As such, an exemplary cleaning fluid used in cleaning system 169 includes, but is not limited to, carbon dioxide. In the exemplary embodiment, carbon dioxide 124 recovered from filter house 130 is directed towards cleaning fluid storage tank 170 and recycled to filter house 130 to be used as the cleaning fluid.

The cleaning fluid may be directed towards filter element 148 at any pressure and temperature that enables the cleaning systems to function as described herein. For example, in the exemplary embodiment, the cleaning fluid is directed at a pressure and temperature that melts the solidified carbon dioxide at surface 154 (shown in FIG. 2) of filter element 148 to facilitate disengaging the solidified carbon dioxide from filter element 148.

The assembly and methods described herein facilitate purifying liquefied natural gas (LNG). In the exemplary embodiments, a flow of LNG-rich slurry is directed towards a filter house, and solidified carbon dioxide in the flow of LNG-rich slurry is collected on a filter element in the filter house. A cleaning system then removes the solidified carbon dioxide from the filter element by either directing a pressurized pulse of cleaning fluid through the filter element, or by melting at least a portion of solidified carbon dioxide to release it from the filter element. Moreover, a valve in the filter house selectively actuates when the solidified carbon dioxide is removed from the filter element to facilitate channeling the carbon dioxide towards a lower portion of the filter house. As such, the solidified carbon dioxide is removed from the flow of LNG-rich slurry to form a flow of purified LNG.

An exemplary technical effect of the methods, systems, and assembly described herein includes at least one of (a) purifying liquefied natural gas more efficiently than other known systems; (b) reducing costs by eliminating natural gas pretreatment systems that remove carbon dioxide prior to natural gas liquefaction; and (c) reducing an ecological footprint of the liquefaction system described herein.

Exemplary embodiments of the natural gas liquefaction system are described above in detail. The system is not limited to the specific embodiments described herein, but rather, components of systems and/or steps of the methods may be utilized independently and separately from other components and/or steps described herein. For example, the filter assembly described herein may also be used in combination with other processes, and is not limited to practice with only the liquefaction system and methods as described herein. Rather, the exemplary embodiment can be implemented and utilized in connection with many applications where improving filtration efficiency of a process stream is desired.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A filter assembly for use in a natural gas liquefaction system, said filter assembly comprising:
a filter house comprising:
a first portion;
a filter element positioned within said first portion and configured to collect solids entrained in slurry on a surface thereof; and
a valve coupled to said first portion; and
a cleaning system coupled to said filter house and configured to remove the solids from said surface of said filter element, wherein said valve selectively actuates to facilitate removal of the solids from said surface of said filter element and channeling of the solids from said first portion through said valve.

2. The assembly in accordance with claim 1, wherein said cleaning system is configured to direct a pulse of cleaning fluid through said filter element to remove the solids therefrom.

3. The assembly in accordance with claim 2, wherein the cleaning fluid includes at least one of methane, nitrogen, and carbon dioxide.

4. The assembly in accordance with claim 1, wherein said cleaning system is configured to direct a flow of cleaning fluid through said filter element, wherein the flow of cleaning fluid is directed at a temperature that melts at least a portion of the solids to facilitate removing the solids from said surface of said filter element.

5. The assembly in accordance with claim 1 wherein said filter house further comprises:
a second portion coupled to said valve and configured to receive the solids channeled through said valve; and
a heater in said second portion configured to at least one of liquefy and sublimate the solids removed from said surface of said filter element.

6. The assembly in accordance with claim 1, wherein said filter element is fabricated from at least one of a ceramic material and a sintered metallic material.

7. The assembly in accordance with claim 1, wherein said valve is in a closed position when said cleaning system is in a first operational mode and said valve is in an open position when said cleaning system is in a second operational mode, wherein said cleaning system is inoperable in the first operational mode, and said cleaning system is configured to remove the solids from said surface of said filter element in the second operational mode.

8. A method of operating a natural gas liquefaction system, said method comprising:
channeling a slurry including liquefied natural gas and solidified carbon dioxide towards a filter house;
collecting the solidified carbon dioxide on a filter element in the filter house to form a flow of purified liquefied natural gas; and
directing a pulse of cleaning fluid through the filter element to remove the solidified carbon dioxide therefrom, wherein the cleaning fluid includes at least one of methane and carbon dioxide.

9. The method in accordance with claim 8 further comprising selectively actuating a valve in the filter house into an open position when the pulse of cleaning fluid is directed through the filter element.

10. The method in accordance with claim 9 further comprising channeling the solidified carbon dioxide removed from the filter element through the open valve and into a lower portion of the filter house.

11. The method in accordance with claim 8 further comprising selectively actuating a valve in the filter house into a closed position when the slurry is channeled towards the filter house.

12. The method in accordance with claim 8 further comprising heating the solidified carbon dioxide removed from the filter element to facilitate forming a flow of carbon dioxide to be discharged from the filter house.

13. The method in accordance with claim 12 further comprising recycling the flow of carbon dioxide into the filter house to be used as the cleaning fluid for removing the solidified carbon dioxide from the filter element.

14. A method of operating a natural gas liquefaction system, said method comprising:
channeling a slurry including liquefied natural gas and solidified carbon dioxide towards a filter house;
collecting the solidified carbon dioxide on a filter element in the filter house to form a flow of purified liquefied natural gas; and
directing a flow of cleaning fluid through the filter element at a temperature that melts at least a portion of the solidified carbon dioxide to facilitate removing the solidified carbon dioxide from the filter element.

15. The method in accordance with claim 14 further comprising selectively actuating a valve in the filter house into an open position when the pulse of cleaning fluid is directed through the filter element.

16. The method in accordance with claim 15 further comprising channeling the solidified carbon dioxide removed from the filter element through the open valve and into a lower portion of the filter house.

17. The method in accordance with claim 14 further comprising selectively actuating a valve in the filter house into a closed position when the slurry is channeled towards the filter house.

18. The method in accordance with claim 14 further comprising heating the solidified carbon dioxide removed from the filter element to facilitate forming a flow of carbon dioxide to be discharged from the filter house.

19. The method in accordance with claim 18 further comprising recycling the flow of carbon dioxide into the filter house to be used as the cleaning fluid for removing the solidified carbon dioxide from the filter element.

20. The method in accordance with claim 14, wherein directing a flow of cleaning fluid comprises directing the flow of cleaning fluid at a temperature and pressure such that at least a portion of the solidified carbon dioxide melts and the cleaning fluid condenses simultaneously.
